(19) United States
(12) Patent Application Publication
(10) Pub. No.: US 2011/0055559 A1
(43) Pub. Date: Mar. 3, 2011

(54) DATA RETENTION MANAGEMENT

(76) Inventors: Jun Li, Mountain View, CA (US); Sharad Singhal, Belmont, CA (US); Ram Swaminathan, Cupertino, CA (US)

(21) Appl. No.: 12/549,179

(22) Filed: Aug. 27, 2009

(51) Int. Cl. G06F 12/14; G06F 12/16; H04L 9/00; G06F 15/76; G06F 17/30

(52) U.S. Cl. 713/165; 712/1; 707/E17.032; 707/E17.005; 380/277; 380/259

(57) ABSTRACT

A file-based data retention management system is provided. A data source can store data files. An online backup file system can make a backup copy of the data files from the data source and store the backup copy of the data files on a backup server. A policy database can be maintained by the system, the policy database including data retention policies for the data files for retention management of the data files. A key management system can assign and manage encryption keys for the data files. The key management system can store the encryption keys on a separate system from the data files stored on the backup server.

### BACKGROUND

Various governmental and other regulatory compliance rules are implemented with which corporations may comply. These rules can make enterprise information lifecycle management (ILM) an important part of a corporate Information Technology (IT) system. Data retention addresses a particular issue in ILM. Data residing within an enterprise often is scheduled to remain valid for up to a certain time period, and after that the data is scheduled to be deleted without any recoverable trace. The timely removal of the data can reduce costs from the enterprise storage management perspective and can also enable the enterprise to manage sensitive data in compliance with stated data retention policies.

Many different types of records or data maybe maintained for a number of years and/or deleted after a number of years due to various regulations. Different records may have different expiry dates. For example, an enterprise may have payroll deduction authorization records which are removed after four years, federal and state tax records which are removed after five years, social security number records which are removed after three years, tax withholding authorization records which are removed after five years, etc. Different enterprises may use different timelines and may maintain any variety of different forms of data and records, the retention of which can be managed by various data management solutions.

Existing data management solutions are concerned with solution scalability up to a single large enterprise and may be deployed primarily within the enterprise domain. As a result, such data management solutions may be inherently unscalable to larger environments, such as a cloud computing environment capable of serving a large number of enterprises, each of which may have up to tens of thousands of users or more, and where each user may have tens of thousands of files or more. Furthermore, currently available solutions focus on data that is online and may ignore data that has been backed up to removable media such as tapes and CD/DVD. The removable media may even be transported to off-site locations that are often not within the direct control of the enterprises themselves. Managing such a large collection of off-sites information assets in an uncontrollable environment can be a daunting task. Off-site information assets can frequently be a root cause of customer data breaches.

### BRIEF DESCRIPTION OF THE DRAWINGS

FIG. 1 is a block diagram of a data retention management system in accordance with an embodiment;

FIG. 2 is a block diagram of a data retention management system implemented in a parallel data processing platform supported by Hadoop Map/Reduce, in accordance with an embodiment; and

FIG. 3 is a flow diagram of a method for managing data retention in accordance with an embodiment.

### DETAILED DESCRIPTION OF EXAMPLE EMBODIMENT(S)

Reference will now be made to the exemplary embodiments illustrated, and specific language will be used herein to describe the same. It will nevertheless be understood that no limitation of the scope of the invention is thereby intended. Additional features and advantages of the invention will be apparent from the detailed description which follows, taken in conjunction with the accompanying drawings, which together illustrate, by way of example, features of the invention.

The systems and methods described provide an Internet-scale file-based data retention system that can allow enterprises to host files in a cloud-computing environment with corresponding file-based retention policies. A scalable, policy-aware data management system hosted in the cloud computing platform can enforce the policies correspondingly. Furthermore, centrally managed encryption keys are used for files hosted in the cloud computing platform, and the data management service can effectively manage file retention of files that are in an encrypted format. Once a file's encryption key is destroyed, all backup versions that have been moved to offsite locations can be instantaneously unrecoverable.

A data management solution is provided for effectively serving a large number of enterprises which addresses issues where data may have left a controlled environment. In one embodiment, a file-based data retention management system is provided where a data source can store data files. An online backup file system can make a backup copy of the data files from the data source and store the backup copy of the data files on a backup server. A policy database can be maintained by the system and the policy database can include data retention policies for the data files for retention management of the data files. A key management system can assign and manage encryption keys for the data files. The encryption keys can be stored by the key management system and can be separated from the data files stored on the backup server. Encryption keys can be centrally managed and/or stored. In one aspect, encryption key stores may be split and backed up to separate servers and/or geographic locations.

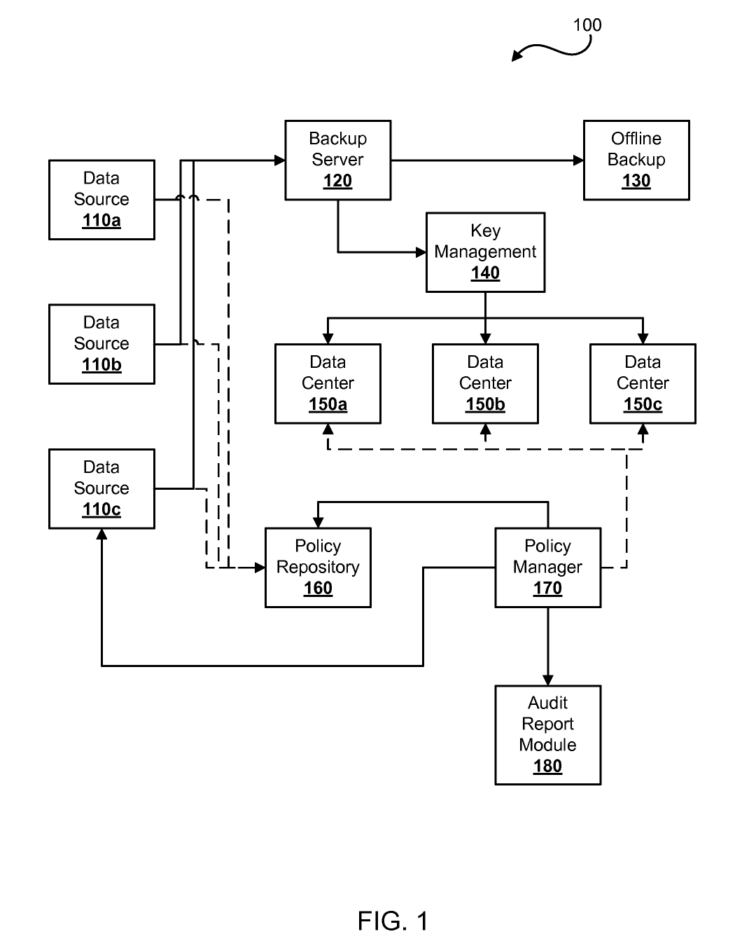

As illustrated in FIG. 1, a system is provided, indicated generally at 100, in an example implementation in accordance with an embodiment for data retention management. Data can be provided to the system from any number of data sources 110a-c. Each data source may store data which can be managed with data retention policies. The data sources can be within an enterprise, or may be scattered across the Internet and may be owned by different organizations. In one aspect, data can come from a distributed file storage system offered by a cloud computing platform. An example of such a distributed file storage system is the Simple Storage Service (S3) from Amazon.com®'s cloud computing platform. In another aspect, data can come from a content management service, such as Microsoft SharePoint®, which may be hosted in a cloud computing platform such as Microsoft's Windows Azure®. In yet another aspect, data may come from a service that is developed and hosted by a different cloud computing platform, such as Force.com® that is offered by Salesforce.®.

Data can be synchronized periodically between a respective data source 110a-c and a backup server 120. An online backup system may be on the backup server 120 and may be hosted by the data management cloud computing platform. As used herein, the term “online” is construed broadly to refer to electronic availability or accessibility of systems, devices or other resources, such as through the internet, a local area network (LAN), a wide area network (WAN), etc. Files can be stored to the online backup system in an encrypted form. In one example embodiment, the files may be encrypted using a unique symmetric key for each file. The symmetric key can become part of meta-data for a data file. When a user logs into the system and accesses a file, the file content can be retrieved by decrypting the file with the encryption key. Although encryption keys are primarily described as symmetric keys herein, other types of encryption keys and encryption schemes may also be implemented. For example, asymmetric encryption keys may be used. The encryption can be manual, transparent, or semi-transparent. Also, different numbers of encryption keys may be used in the different encryption schemes. Some examples include one-key, and two-key encryption schemes.

In one aspect, the online backup system may provide file synchronization from the data source. The online backup system may also be used for file retrieval back to the data source. Thus, the online backup system does not need to be at a real-time file operation path from the application that processes files in the data source. As a result, the overhead by the encryption in the online backup file system during data synchronization may not be a performance concern. When data files are uploaded to the online backup system, the data files can be stored on the backup server 120 in an encrypted format.

In one embodiment, data files stored in the online backup system can be further archived to an offline backup system 130. The offline backup system may be any form of offline backup as known in the art. In certain embodiments, the offline backup system comprises an offline tape-based or optical media backup system. The archiving of the online backup system to the offline backup system can be performed according to predefined backup schedules.

A centralized key management system 140 can be included for providing a highly available online key store capable of storing the encryption keys for the files assembled or backed up from all of the different data sources. To achieve high availability, the key store can be cloned and distributed to multiple data centers 150a-c. Unlike the files in the online backup system which can be periodically backed up to offline media, the key store is not saved to offline media. This can ensure that keys that have been destroyed cannot be retrieved from backups.

The data centers to which the key store is distributed can take any of a variety of forms. For example, a data center may comprise a computer or a server, or may comprise a cluster or cloud of computers or servers. In one aspect, the data centers may be at geographically separate locations. The term “geographically separate”, as used herein, refers to geographic locations which are separated by at least some minimal distance for protecting data at one data center in the event that data at a different data center is damaged or comprised in some way, such as through hacking, natural disaster, terrorist attack etc. For example, one data center may be in one room, building, city, state, country, continent, etc., and another data center may be in a different room, building, city, state, country, continent, etc.

A policy repository 160 can store data retention policies for files or directories. In one aspect, the policy repository can be a policy database. Data retention policies can be specified by a user and may be changed by a user at any time. The data retention policies may be specified by a user at the time the file is created. Alternatively, data retention policies can be specified in different ways. For example, retention policies can be specified within the context that the files are produced. Specifically, files related to a negotiated contract may need to be retained for a period of three years, or files related to taxes may need to be retained for five years. Additionally, data retention policies can be based on specified file directories or specific users. In a more detailed aspect, the specified file directories may correspond to a particular organization or project within an enterprise. Each organization within a corporation can have organization-specific data retention policies which may be derived from high-level corporate policies. Different corporations or enterprises may also adopt or implement different retention policies.

A policy manager 170 can be configured to periodically scan through the policy repository to identify files that have expired retention periods. The policy manager can be configured to delete files with expired retention periods or simply mark them for deletion by another system, a user, or a system administrator. Activities performed by the policy manager can be logged for audit purposes and the logs may be queried and/or reported through an audit report module 180.

When a data synchronization or backup action by the backup server or backup system creates a new file in the online backup system, a file encryption key can be created. The encryption key can remain valid for the entire lifetime of the file. As described above, a retention policy and/or retention period can be changed by a user or enterprise. If the retention period is changed, the lifetime of the file will change as well. The validity of the key will last as long as the policy manager has not determined that the file retention period has expired.

A lifetime of a file may extend past when a file is deleted from the data source. For example, a file may be purposefully or inadvertently deleted from the original data source by a user. The user may determine at a later period that the file was important and wish to have the file restored. While the periodic synchronization between the backup server and the data source may cause the data file to be deleted from the backup server, the offline backup system may have a copy of the data file. As long as the retention period for the deleted file has not expired, the file can be restored from the offline backup using the encryption keys. In another aspect, if the data file still exists on the backup server, the file may be restored from the backup server.

When a file is updated, no changes may be made to the encryption key associated with that file. When a file is removed from a data source, the file is also removed from the online backup system. However, the file's encryption key may not be removed from the key table until the retention period for the file and/or the encryption key associated with the file has expired. Instead, a flag (e.g., Boolean) may be introduced into at least one of the key management system and the file backup server to indicate that the file has been removed from the online backup system. This can enable the system to retrieve (and decrypt) old files from backup media as long as their retention times have not been reached, as has been described above.

In one embodiment, a file having a file name and an assigned encryption key can be identified by its fully qualified path in the file system, and the file can be deleted by the user. If a file with a same file name is created again at a later time, the later file can be considered a different file and a new key may be generated for that file. In other words, encryption keys may be retired after a single use to enhance the security of the system.

The encryption keys managed by the key management system may be stored in a key store or key repository. In one aspect, the key store may be a large table with a plurality of fields. One example field is a Uniform Resource Identifier (URI). The URI may be used to indicate a fully qualified path of a file in the online backup system. The URI may also indicate a creation time of a file in the online backup system. Another field may include a Boolean flag. The Boolean flag may be used to represent whether the file has been removed from the data source. Another field may include a binary array. The binary array may be used to represent a file-specific encryption key. In one aspect, the binary array may comprise up to 16 or 32 bytes or more. Other types of fields may also be included in the key store.

As has been briefly described above, the key store may be periodically backed up to multiple data centers to achieve high availability and mitigate a risk due to data center level disasters (e.g. earthquake, flood, etc.). To prevent illegal access of the key store at the backup data center and reduce the possibility of the key store being compromised, backup copies of the key store can be broken up into blocks, encrypted using master keys for each data center, and distributed to the data centers. In one aspect, the key store is broken into blocks using a Reed Solomon algorithm or other encoding/interleaving algorithm. Such an algorithm may be used for partitioning data, such as into data blocks. In one aspect, each block may contain only a portion of the key data. In this way, even if a data center were compromised, the full key store may not be accessible or available to a hacker.

In one embodiment, in each backup data center, only the most recent backup key file is kept. The backup key file may be kept online without being further backed up to another backup media. Only keeping the most recent backup key file can assure that only a single key file is present for the entire system at any time. Otherwise, historical key files could be potentially recovered from a backup media and files could become retrievable from the backup media after a data retention period for the file(s) has expired. Backup of the key store to data centers can be done instantaneously or substantially instantaneously. In another aspect, the backup of the key store may be performed periodically. For example, the key store may be backed up every certain number of hours, daily, or any other desired predetermined period of time. A potential drawback to periodic updating of the key store to the data centers is that changes made to the key store between synchronization times may be lost through disaster or other cause of data loss at a primary data center. To provide some degree of additional redundancy, audit logs may be used to ‘replay’ the actions taken between key store backups by the policy manager with regards to files or keys in order to re-create the final key store, if the audit logs can avoid data loss in the same incident that occurs to the key store. In this way, a higher degree of recoverability may be provided for data and encryption keys between updating and synchronization retention keys to the data centers.

To prevent improper access of the key store and to reduce the possibility of the key store being compromised, the key store can be encrypted using a master key. In one aspect, there may be a master key associated with each of the data blocks described above. Alternatively, a single master key may be used to encrypt the key store either before the key store is broken into data blocks or when the key store is not broken into data blocks. The master keys as well as the distribution algorithm for breaking up the key store can be kept in physically secure media (such as a Universal Serial Bus (USB) drive, optically readable media (such as Compact Disc Read-Only Memory (CD ROM) and DVD), or any other suitable form of computer readable storage medium). In one aspect the physically secure media may be portable and may be removable from the system. The physically secure media may also be guarded through various means. For example, the physically secure media may be kept in a secure vault at a bank.

As has been briefly described above, the policy manager can periodically scan through the policy repository to identify data files with retention periods which have expired since the last scan. The policy manager can then take appropriate policy enforcement steps. Any variety of policy enforcement steps may be taken. In one example, the policy enforcement steps taken may include one or more of: deleting the encryption keys in the key store for the expired files; removing online backup system files corresponding to the data files with expired retention periods; and invoking Application Programming Interfaces (APIs) exposed by the data source to remove the data files (or the corresponding data information) from the original data source. For example, an API may be used to remove a file stored in Microsoft SharePoint®.

Removing data files from the original data source may take some time and may be better performed in an asynchronous manner. However, each of the policy enforcement steps taken may also performed synchronously or asynchronously. For asynchronous actions, such as removing data files from the data source, a task queue may be used to hold the file removal actions for corresponding data sources. The task queue may include a database table, or other queue structure in which the file removal actions, the corresponding data sources, and the time stamps of the enqueued file actions, are maintained. A task tracker can periodically scan the task queue and perform the file removal actions in a desired order. The file removal actions may be performed according to of the timing order of which action entered the queue first or which action has a higher level of importance.

When the policy manager removes encryption keys from the key store, all existing online and offline backup media associated with the corresponding file can be rendered unrecoverable instantaneously. Actions taken by the policy manager (e.g., the removal of the key from the key store, the removal of the file from the online backup system, in particular, from the backup server 120, the removal of the original data in the data source, etc.) can be logged by the audit module for auditing purposes. The audit log can be queried by users or auditors from the enterprise that owns the files. The audit module can also be configured to provide partial or complete audit reports at predetermined intervals or after predetermined events without having users or auditors query the system. Additionally, the audit logs can assist in providing a degree of recoverability for data and encryption keys between updating and synchronization of encryption keys to the geographically distributed data centers, as described previously.

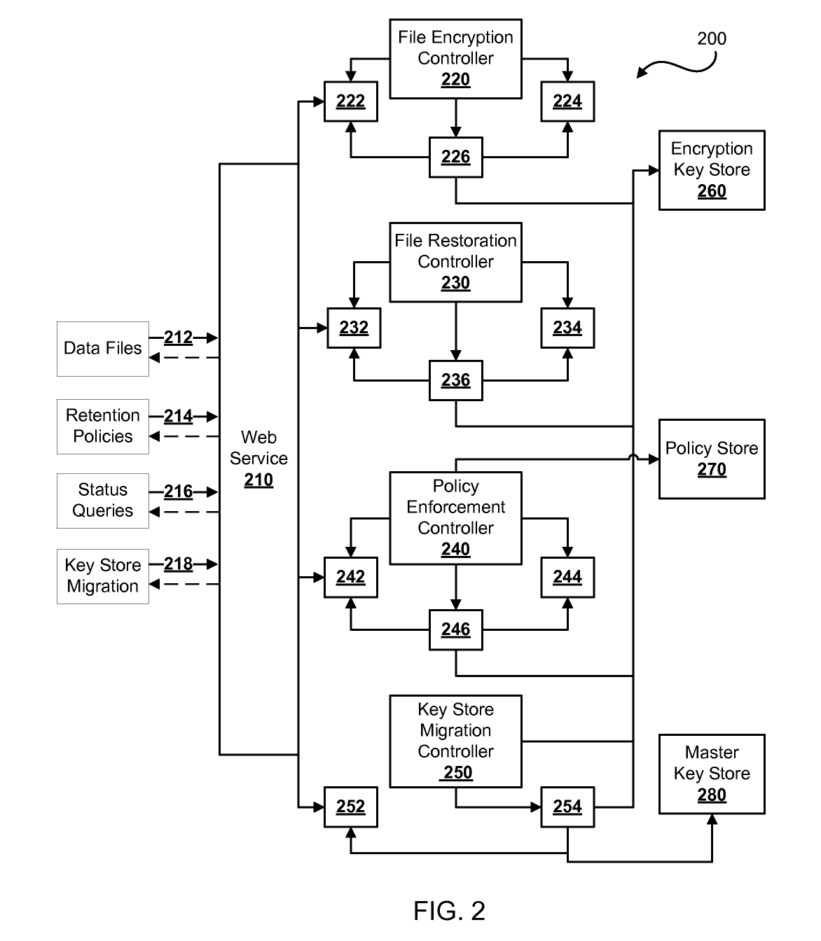

Referring now to FIG. 2, a data retention management system is provided with Hadoop-based parallel processing support. Hadoop is an open-source large-scale parallel processing platform or architecture. Hadoop can support a distributed file system and a map/reduce computing architecture to process a large volume data stored in a Hadoop distributed file system. H Base is a large-scale distributed storage system to manage structured data and is built upon Hadoop. An HBase table can be persistent. FIG. 2 shows a system architecture that is built upon Hadoop, Hadoop map/reduce, and HBase, which can be used to achieve the system shown in FIG. 1.

Map/reduce is a programming model and an associated implementation for processing and generating large data sets. The input data file can be divided into independent data segment which are processed by the map tasks that are carried out on different processors in the machine cluster in a completely parallel manner. Each map task can carry out a user-defined map function to process a key/value pair from an input data segment to generate a set of intermediate key/value pairs. The map/reduce framework sorts the outputs of the map tasks based on the intermediate keys. The outputs are then distributed to the reduce tasks. Each reduce task carries out a user-defined reduce function that merges all intermediate values associated with the same intermediate key. Similar to the map tasks, the reduce tasks can also be carried out on different processors in the machine cluster in a parallel manner. With map/reduce, data processing can be parallelized and executed on a large cluster of machines. A run-time system, such as Hadoop, can take care of the details of partitioning the input data, scheduling the program's execution across a set of machines, handling machine failures, and managing required inter-machine communication.

In the system 200 of FIG. 2, a web service 210 is provided through which an enterprise or a user may interact with the data retention management system. The web service can serve as a front end for the data retention management system. Web service application programming interfaces (APIs) can support file-related operations for an online backup file system, file-based data retention policy management, querying of the processing status of different operations (e.g., file encryption and file restoration, which can potentially have long latency and even involves with human activities), and migration of key stores to other data centers.

Arrows 212, 214, 216, 218 can represent calls made by a user or enterprise to the web service 210 and the results of the corresponding web service calls are indicated as the dash-lines in the reverse direction. For example, call 212 can represent the service calls related to data files. For example, a data file service call may be a file uploading service call from which the user's files are uploaded to the data retention management system. The returned result of the file uploading may be a processing status of the data file (i.e., whether file uploading succeeded or failed, etc.). Call 214 can represent service calls related to the assignment or retrieval of data retention policies associated with the data files to the data retention management system. Call 216 can represent service calls for status reports or status queries. For example, a status query may be to ask whether a particular user file has had an associated data retention policy enforced. Call 218 can represent a service call related to migration of the encryption key store to geographically distributed data centers. An incoming volume of data, policies, etc. into the web service may be high, and the system may be benefited by providing a robust processing capability in order to encrypt and process incoming data. In one aspect, the incoming data may be queued for encryption key creation, file encryption, file decryption, file backup, retention policy enforcement, key store management, etc. Hadoop and map/reduce functions may be used as a scheduler for scheduling or queuing the processing of the various tasks and files across multiple machines, and have the processing of the various tasks and files performed in the machine cluster in a coordinated manner.

The web service 210 can interface with system 200 components, such as a file encryption controller 220, a file restoration controller 230, a policy enforcement controller 240, and a key store migration controller 250. Each controller can coordinate message queue-based batch processing and may follow a similar processing pattern to the other controllers. For example, the file encryption controller can monitor a file encryption pending queue 222. The file encryption pending queue can be a message queue configured to hold files or file addresses for pending encryption. The file encryption pending queue can be implemented as an HBase table. At predetermined intervals, such as 30 seconds for example, the file encryption controller can take a snapshot of the file encryption pending queue to construct a file pending encryption queue snapshot file. The file pending encryption queue snapshot file can be sent to a map/reduce-based job controller 226. The map/reduce-based job controller can then distribute the file encryption processing tasks, which are encoded in the snapshot file, to a collection of machines in a machine cluster. The collection of machines may comprise a variety of different servers, processors, etc., which are capable of processing the file encryption tasks. In a map processing phase, the actual file encryption can be carried out and the encryption key that is used to encrypt the file can be stored into the key store 260. Also, the queued item's status can be updated to both the message queue (i.e., the file encryption pending queue) and also a status reporting table 224, which can be implemented as a different HBase table. In one aspect, the reduce phase can be assigned to do nothing, because encryption processing and encryption status update have been carried out in the map phase already. The file encryption controller associated status reporting table 224 can be exposed to the web service, such that the table can be queried for the file encryption status by the user for a particular file, or a batch of the uploaded files, via the web service 210.

The file restoration controller 230 may operate in a similar fashion as the file encryption controller 220. For example, a file restoration pending queue 232 (which may be implemented as an HBase table) can hold files or file addresses for which file restoration is pending. The file restoration controller can take a snapshot of the queue to create a file restoration pending queue snapshot file to send to a map/reduce-based job controller 236. The map/reduce-based job controller 236 can then distribute file restoration processing tasks which are encoded in the file restoration pending queue snapshot file to a collection of machines in a machine cluster. In a map processing phase, file restoration can be carried out and the encryption key can be retrieved from the key store 260. Also, the queued item's status can be updated to both the message queue (i.e., the file restoration pending queue) and also a status reporting table 234, which can be implemented as an HBase table. In one aspect, the reduce phase can be assigned to do nothing, because file restoration and file restoration status update have been carried out in the map phase already. The status reporting table 234 can be exposed to the web service such that a user can query the status reporting table for file restoration status of a particular file or a batch of files.

The policy enforcement controller 240 may operate in a similar manner as the file encryption controller 220 and the file restoration controller 230 with regards to an enforcement pending queue 242, a map/reduce-based controller 246, and a policy enforcement status table 244. In one aspect, the policy enforcement controller can also be configured to communicate with a policy store 270. In one aspect, the policy store can be implemented as an HBase table. The policy store can hold data retention policies as defined by a user or enterprise. The policy store can receive the policies through the web service and have the policies stored in the policy store. The policy enforcement controller can query the policy store to retrieve policies for use in enforcement of data retention policies.

The key store migration controller 250 can be used to encrypt the encryption key store by creating a snapshot file of the encryption key store and encrypting the snapshot file. The encryption key required to encrypt the snapshot file can be stored in a master key store 280. A map/reduce-based controller 254 may be utilized in the encryption process. In one embodiment, the job controller 254 can use a map/reduce job to come up with a snapshot file for the encryption key store, and then perform the encryption on the snapshot file, based on the encryption key provided from the master key store 280. The output of this map/reduce job can be an encrypted encryption key store file 252, that is ready to be distributed to a geographically distributed data center. The key store migration can be exposed as a service call from the web service 210. Correspondingly, to recover the encryption key store 260, multiple encrypted encryption key store files 252 from geographically distributed data centers can be imported to the data retention management system which can use the key store migration controller 250 to reconstruct the encryption key store 260. In another aspect, the encryption key store file 252 may be a file which is provided for access through the web service for downloading, uploading, and/or safekeeping.

To prevent illegal access of the key store at the backup data center and reduce the possibility of the key store being compromised, the total encryption key store may be broken into different data blocks after the snapshot file for the total encryption key store is produced. Different data blocks can be encrypted with different keys. The different keys can be stored in the master key store 280. Each encrypted encryption key store file 252 may thus be only a portion of the total encryption key store.

The data stores, such as the encryption key store 260, policy store 270, master key store 280, status reporting related tables 224, 234, 244, and message queues 222, 232, 242, can be implemented as HBase Tables in order to hold a large number of structural data in each of these tables. The HBase tables can support row-based atomic operations.

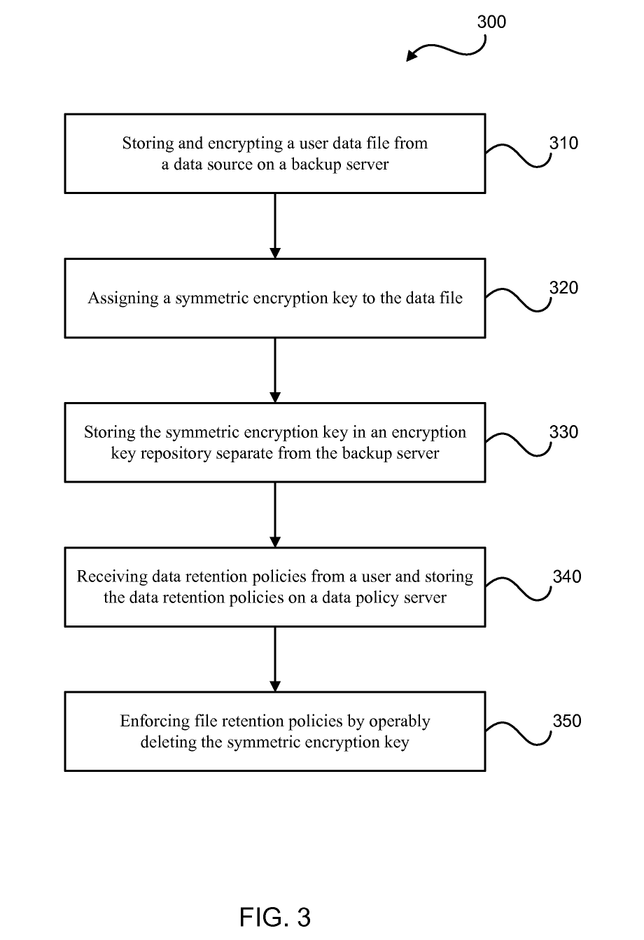

Referring to FIG. 3, a method 300 for managing data retention is shown, in accordance with an embodiment. A user data file from a data source can be stored 310 and encrypted on a backup server. A symmetric encryption key can be assigned 320 to the data file. The symmetric encryption key can be stored 330 in an encryption key repository separate from the backup server. Data retention policies can be received 340 from a user and storing the data retention policies on a data policy server. File retention policies can be enforced 350 by deleting the stored encryption key.

The method may further comprise splitting the encryption key repository into encryption key blocks. Storing the key separate from the backup server may further comprise sending at least one encryption key block containing a group of the keys to each of a plurality of geographically separated data centers. The encryption key repository can be encrypted using a master key before the repository is sent to a geographically separated data center. The master key can be stored on a portable computer readable storage medium. The master key can be changed periodically.

Enforcing file retention policies may further comprise deleting at least one of a data file at the data source and a data file on the backup server. Deleting a data file at the data source may further comprise obtaining permission from the user before deleting the data file. In one aspect, a reporting module can report to a user when at least one of an expired retention period for the data file and a deletion of a data file has occurred. The data file can be continued to be stored, at least temporarily, on the backup server and the encryption key associated with the data file may also be continued to be stored when a user deletes the data file from the data source and the retention period for the data file has not expired unless the user requests that at least one of the data file on the backup server and the encryption keys be deleted. When the user requests the data file to be deleted from the backup server, the corresponding encryption key stored in the encryption key store may not be deleted unless the user explicitly requests that the encryption key be removed. A data file accidentally deleted by the user can be restored using the encrypted data file stored on the backup server, if the encrypted data file still exists on the backup server, or may be restored from an encrypted data file stored on the offline backup system The encryption key stored in the encryption key repository can be used to access the encrypted data file when the retention period for the accidentally deleted data file has not expired.

The data management systems and methods provided herein can offer a scalable solution that may be based on an internet-scale structural data store in order to manage a large number of enterprises, each of which may have thousands of users or more, and where each user may have thousands of files or more to be managed. A centrally managed key store as described herein can effectively control validity of online files, as well as backup versions of the files which may have been transported to some off-site environments. Manageability of online or offline files can be useful in various situations, especially where the backup media may no longer be in the direct control of the enterprise that owns the files. The data retention policy enforcement can be accomplished through effective management of the file encryption keys stored in a highly available environment, where multiple geo-replicates are available to accommodate data center level disasters. The offline file backups that come out of the data management system can be inherently in an encrypted format, and as long as the encryption keys of the backed up files are kept in the safe place, files on the backup media cannot be decrypted by a third party in the event that backup media is lost or stolen.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

1. A file-based data retention management system, comprising:
a data source configured to store data files;
an online backup file system configured to make an encrypted backup copy of the data files from the data source and to store the backup copy of the data files on a backup server;
a policy database comprising data retention policies for the data files for retention management of the data files; and
a centralized key management system configured to assign and manage encryption keys for the data files and to store the encryption keys on a separate system from the data files stored on the backup server.

2. A system in accordance with claim 1, wherein the key management system is configured to encrypt the encryption keys with a master key and the system further comprises a portable computer readable storage medium configured to store the master key.

3. A system in accordance with claim 1, wherein the key management system is configured to split the encryption keys into encryption key blocks, and further comprising a plurality of geographically separated data centers each configured to receive at least one of the encryption key blocks.

4. A system in accordance with claim 1, further comprising an offline backup computer readable storage medium configured to receive and store backups of the data files on the backup server.

5. A system in accordance with claim 1, further comprising a policy enforcement module configured to enforce file retention policies by deleting encryption keys assigned to data files with expired retention periods.

6. A system in accordance with claim 1, further comprising a policy database comprising data retention policies for the received data and usable by the policy enforcement module in managing retention of the received data files.

7. A system in accordance with claim 1, further comprising a reporting module configured to report at least one of an expired retention period for a data file and deletion of a data file for which the retention period has expired.

8. A system in accordance with claim 1, further comprising a large-scale parallel processing architecture configured to process large volumes of data files stored using the file-based data retention management system.

9. A file-based data retention management system, comprising:
a data source configured to store data files;
an online backup file system configured to make an encrypted backup copy of the data files from the data source and to store the backup copy of the data files on a backup server;
a policy database comprising data retention policies for the data files for retention management of the data files;
a key management system configured to assign and manage encryption keys for the data files and split the encryption keys into encryption key blocks; and
a plurality of geographically separated data centers each configured to receive at least one of the encryption key blocks.

10. A method for file-based data retention management, comprising:
storing and encrypting a user data file from a data source on a backup server;
assigning a symmetric encryption key to the data file;
storing the symmetric encryption key in an encryption key repository separate from the backup server;
receiving data retention policies from a user and storing the data retention policies on a data policy server;
enforcing file retention policies by operably deleting the symmetric encryption key.

11. A method in accordance with claim 10, further comprising splitting the encryption key repository into encryption key blocks.

12. A method in accordance with claim 11, wherein storing the symmetric encryption key separate from the backup server further comprises sending at least one encryption key block to each of a plurality of geographically separated data centers.

13. A method in accordance with claim 10, further comprising encrypting the encryption key repository using a master key.

14. A method in accordance with claim 13, further comprising storing the master key on a computer readable storage medium.

15. A method in accordance with claim 13, further comprising periodically changing the master key.

16. A method in accordance with claim 10, wherein enforcing file retention policies further comprises operably deleting at least one of a data file at the data source and a data file on the backup server when a file retention period has expired.

17. A method in accordance with claim 10, further comprising processing large volumes of data files stored using a large-scale parallel processing architecture implemented in a file-based data retention management system.

18. A method in accordance with claim 10, further comprising reporting at least one of an expired retention period for the data file and deletion of a data file for which the retention period has expired to a user using a reporting module.

19. A method in accordance with claim 10, further comprising:
continuing to store the data file on the backup server at least temporarily unless the user requests deletion of the data file on the backup server; and
continuing to store the symmetric encryption key associated with the data file when the user deletes the data file from the data source and the retention period for the data file has not expired unless the user requests deletion of the symmetric encryption key associated with the data file.

20. A method in accordance with claim 10, further comprising restoring a data file accidentally deleted by the user using the data file stored on the backup server and the symmetric encryption key stored in the encryption key repository when the retention period for the accidentally deleted data file has not expired.
